(19) United States
(12) Patent Application Publication
(10) Pub. No.: US 2007/0089136 A1
(43) Pub. Date: Apr. 19, 2007

(54) Program recommendation method and program recommendation apparatus

(75) Inventors: Hiroyuki Kumai, Kunitachi (JP); Konagi Uchibe, Machida (JP); Yasutsugu Morimoto, Kodaira (JP)

Correspondence Address: Stanley P. Fisher;Reed Smith LLP, Suite 1400, 3110 Farirview Park Drive, Falls Church, VA, 22042-4503, US

(73) Assignee: Hitachi, Ltd.

(21) Appl. No.: 11/545,590

(22) Filed: Oct. 11, 2006

(30) Foreign Application Priority Data
Oct. 17, 2005 (JP) 2005-301645

(51) Int. Cl. H04N 5/445; G06F 3/00; H04N 7/16; H04H 9/00

(52) U.S. Cl. 725/46; 725/9; 725/13

(57) ABSTRACT

Provided is a program recommendation method for a computer system including: a program distribution server in which program information is stored, a schedule storing unit for storing a schedule of a user, and a program recommendation unit for recommending programs from the program information, comprising the steps of: recommending, in case of which a schedule to be an object of program recommendation is stored in the schedule storing unit, at least a program from the program information stored in the program distribution server based on the stored schedule; searching for a period that is before a start time of the schedule of an object of program recommendation and in which it is possible for the user to watch the programs recommended by the program recommendation unit; and registering a program watching schedule, which is a schedule for watching programs recommended in the searched period, in the schedule storing unit.

### CLAIM OF PRIORITY

The present application claims priority from Japanese patent application 2005-301645 filed on Oct. 17, 2005, the content of which is hereby incorporated by reference into this application.

### BACKGROUND OF THE INVENTION

This invention relates to a method of recommending a program particularly suitable for a schedule of a user from program information of programs of television, radio, multimedia contents on the Internet, and the like and schedule information of the user.

According to the advent of the broadband networks such as the Internet and the program distribution server capable of performing sound recording and video recording for a long time, the age of the broadcast type watching for watching programs in accordance with program schedules of broadcasting stations has ended and the age of the on-demand type watching for allowing users to select and watch favorite programs when the users like has come.

The number of programs that the users can watch is steadily increasing according to the reduction in content production costs, the increase in producers, and the provision and accumulation of borderless programs such as dramas in foreign countries.

On the other hand, human ability for watching more programs has not been remarkably improved. The number of programs that the users can watch has far exceeded the number of programs that the users can grasp and select. Therefore, users of program players have a problem in that the users have to decide which program to watch among a large number of programs.

In order to solve the problem, a technique for extracting a taste of a user from a watching history of the user, detecting programs matching the taste using program information, and presenting the programs to the user is disclosed in JP 2002-320159 A.

In JP 2002-073926 A, a technique in which a system recommends, on the basis of content of a schedule registered by a user, information such as an advertisement suitable for the schedule and displays the information beside an object schedule.

### SUMMARY OF THE INVENTION

Watching programs can be roughly classified into watching for the purpose of entertainment and watching for the purpose of obtaining information useful for a user. The former watching relies on a taste, mood, or the like of the user and there is almost no time limit for watching. However, a time limit for watching is often set for the latter watching. For example, a value of watching a program concerning a theme of a meeting is higher before the meeting is held than after the meeting is held.

However, in the related art described above, even if a program is recommended, time required by the user to watch the program or obtain the information is not taken into account. It is assumed that content of a schedule and watching a program are independent from each other. Therefore, time in which the user watches the recommended program is not secured simultaneously with the recommendation of the program with respect to a schedule of the user.

For example, in the related art, when the user registers a business trip destination in a schedule on a day of the business trip, an advertisement of an event performed at the business trip destination is inserted into the schedule on the day of the business trip. However, time for watching the advertisement of the event is not taken into account. Even if the advertisement is a thirty minute motion advertisement program including abundant information, it is not considered whether the user can watch the advertisement until the business trip ends. It is highly likely that the user leaves for home without watching the information after all. If a schedule of the business trip is registered a few days before the business trip, there are many candidates of time in which the user can watch programs. Thus, it is more likely that, until the business trip, the user has more opportunities for watching useful programs related to the business trip.

Thus, in a program recommendation method according to this invention, programs to watch are recommended to a user on the basis of a schedule registered in a schedule book of the user and time in which the user watches the program is registered in a schedule before scheduled time of a program recommendation object.

According to a representative aspect of this invention, there is provided a program recommendation method for a computer system including a program distribution server in which program information is stored, a schedule storing unit for storing a schedule of a user, and a program recommendation unit for recommending programs from the program information, including the steps of:

recommending, in case of which a schedule to be an object of program recommendation is stored in the schedule storing unit, at least a program from the program information stored in the program distribution server based on the stored schedule; searching for period that is before a start time of the schedule of an object of program recommendation and in which it is possible for a user to watch the programs recommended by the program recommendation unit; and registering a program watching schedule, which is a schedule for watching programs recommended in the searched period, in the schedule storing unit.

According to this invention, it is possible to extract programs related to a schedule of a user, secure time for watching the programs before the schedule, and automatically register the time in a schedule storing unit as a program watching schedule. Thus, the user can surely watch the programs related to the schedule prior to the schedule. Therefore, the user can watch the programs related to the schedule before the schedule and increase knowledge in advance to appeal the user himself/herself in a meeting, a business talk.

### BRIEF DESCRIPTION OF THE DRAWINGS

The present invention can be appreciated by the description which follows in conjunction with the following figures, wherein:

FIG. 1 is a system diagram of a computer system according to an embodiment of this invention;

FIG. 2 is a table of program list information according to the embodiment of this invention;

FIG. 3 is a table of a schedule book according to the embodiment of this invention;

FIG. 4 is a table of a default schedule according to the embodiment of this invention;

FIG. 5 is a table of an address book according to the embodiment of this invention;

FIG. 6 is a table of reference prioritization according to the embodiment of this invention;

FIG. 7 is a flowchart of program recommendation processing according to the embodiment of this invention;

FIG. 8 is a flowchart of program watching schedule planning processing according to the embodiment of this invention;

FIG. 9 is a diagram showing a screen for setting of a priority registration method of planning of watching programs according to the embodiment of this invention;

FIG. 10 is a table of a place and type of watching place table according to the embodiment of this invention;

FIG. 11 is a table of a type of watching place and prior genre table according to the embodiment of this invention;

FIG. 12 is a flowchart of processing for coping with time when it is impossible to store programs according to the embodiment of this invention;

FIG. 13 is a diagram showing an alert screen according to the embodiment of this invention;

FIG. 14 is a table of a schedule book after registration of a program watching schedule according to the embodiment of this invention;

FIG. 15 is a diagram showing a schematic display screen of the schedule book after registration of a program watching schedule according to the embodiment of this invention;

FIG. 16 is a diagram showing a detailed display screen for a schedule registered as a program watching schedule according to the embodiment of this invention; and

FIG. 17 is a diagram showing a schematic display screen of the schedule book after registration of a program watching schedule according to the embodiment of this invention.

### DETAILED DESCRIPTION OF THE PREFERRED EMBODIMENTS

An embodiment of this invention will be hereinafter explained with reference to the accompanying drawings.

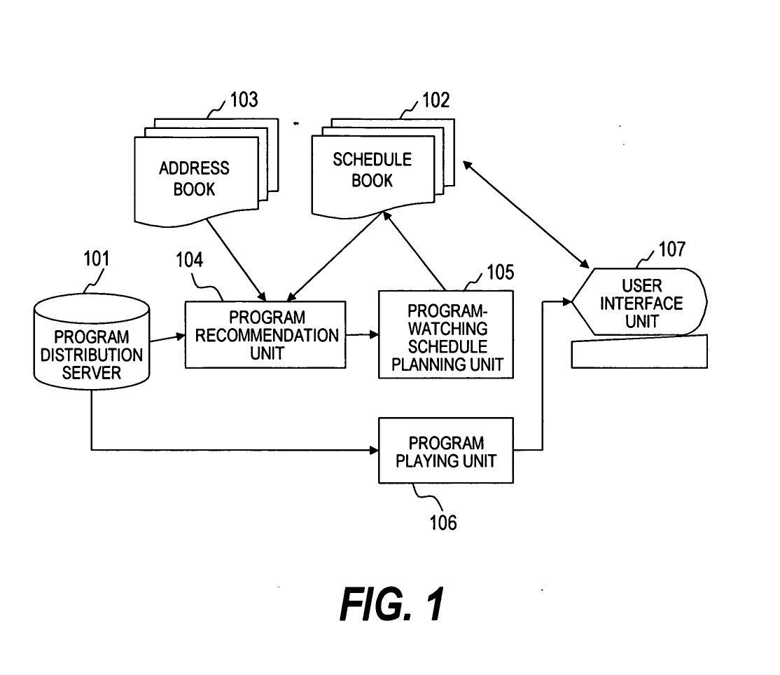

FIG. 1 is a system diagram showing a structure of a computer system according to the embodiment of this invention.

The computer system includes a program distribution server 101, a schedule book 102, an address book 103, a program recommendation unit 104, a program watching schedule planning unit 105, a program playing unit 106, and a user interface unit 107.

The program distribution server 101 stores program list information 200 and programs in a storage device (not shown) of the program distribution server 101. The program distribution server 101 subjects the program list information 200 and the programs to processing such as digital compression and delivers the program list information 200 and the programs according to a request of a user. Only the program list information 200 has to be stored in the program distribution server 101 and a server for storing the programs may be provided separately from the program distribution server 101.

The schedule book 102 is a schedule storing unit for registering schedules of the user and constituted by a storing unit such as a memory. The schedules of the user are registered in the storing unit by the user.

The address book 103 is constituted by a storing unit such as a memory. Information on people and organizations related to the user are registered in the storing unit of the address book 103 by the user.

The program recommendation unit 104 recommends a program from the program list information 200 on the basis of a schedule of a program recommendation object among the schedules registered in the schedule book 102.

The program watching schedule planning unit 105 registers a schedule for watching the program recommended by the program recommendation unit 104 at time before the schedule of the program recommendation object and time in which watching is possible.

The program playing unit 106 converts the program subjected to digital compression and transmitted by the program distribution server 101 into a video signal and an audio signal and transmits the video signal and the audio signal to the user interface unit 107.

The user interface unit 107 displays the programs, the program list information 200, the schedules of the user in the schedule book 102, and the information on people and organizations related to the user in the address book 103. The user interface unit 107 performs input in the schedule book 102 and the address book 103.

The program distribution server 101, the schedule book 102, the address book 103, the program recommendation unit 104, the program watching schedule planning unit 105, the program playing unit 106, and the user interface unit 107 can be implemented in a computer including a memory, a storage device, a microprocessor for performing an arithmetic operation, a display, a keyboard, and the like.

Also, those units can be implemented in a computer integrated apparatus such as a television, a hard disk recorder, or a portable terminal that includes the same structure as the computer.

It is possible to constitute the program distribution server 101 with a storage device in the computer and a control program. Alternatively, it is possible to constitute the program distribution server 101 with a storage device on the outside and another apparatus connected to a program recommendation apparatus via a network as in an on-demand service for delivering programs selected by users for each of the users.

It is also possible to constitute the user interface unit 107 with independent another apparatus. For example, it is possible to constitute the user interface unit 107 with a game machine, a cellular phone, or the like that is connected to a computer main body located in the user's home through a network by radio and capable of reproducing programs.

In this embodiment, the user can watch programs using the user interface unit 107 of a portable type or a stationary type provided separately from the program recommendation apparatus. An environment serving as a ubiquitous network accessible to the schedule book 102 and the address book 103 provided separately from the program recommendation apparatus is assumed.

The program recommendation apparatus only has to be a computer including at least the program recommendation unit 104, the program watching schedule planning unit 105, a processor, a main memory, and a storage device. Various variations of the program recommendation apparatus are possible.

The programs according to this invention are not limited to videos in a television broadcast and the like and sound in a radio broadcast and the like. For example, in a text that is character information, it is possible to calculate speed of cognition from average reading speed of people. Time in which page ejection, scroll, and the like are automatically performed can be defined as a running time on the basis of a numerical value of the speed of cognition. In a still image of a photograph collection and the like, time in which automatic switching display of images is performed on the basis of cognition processing time for a human image can be defined as a running time. In other words, what are called programs herein include: audio visual media contents such as videos, sound, texts, and still images; media contents causing a sense of taste, a sense of smell, and a sense of touch; and complex contents of those media contents, reproduction and cognition of which require time enough to be allocated in a schedule in a human daily life.

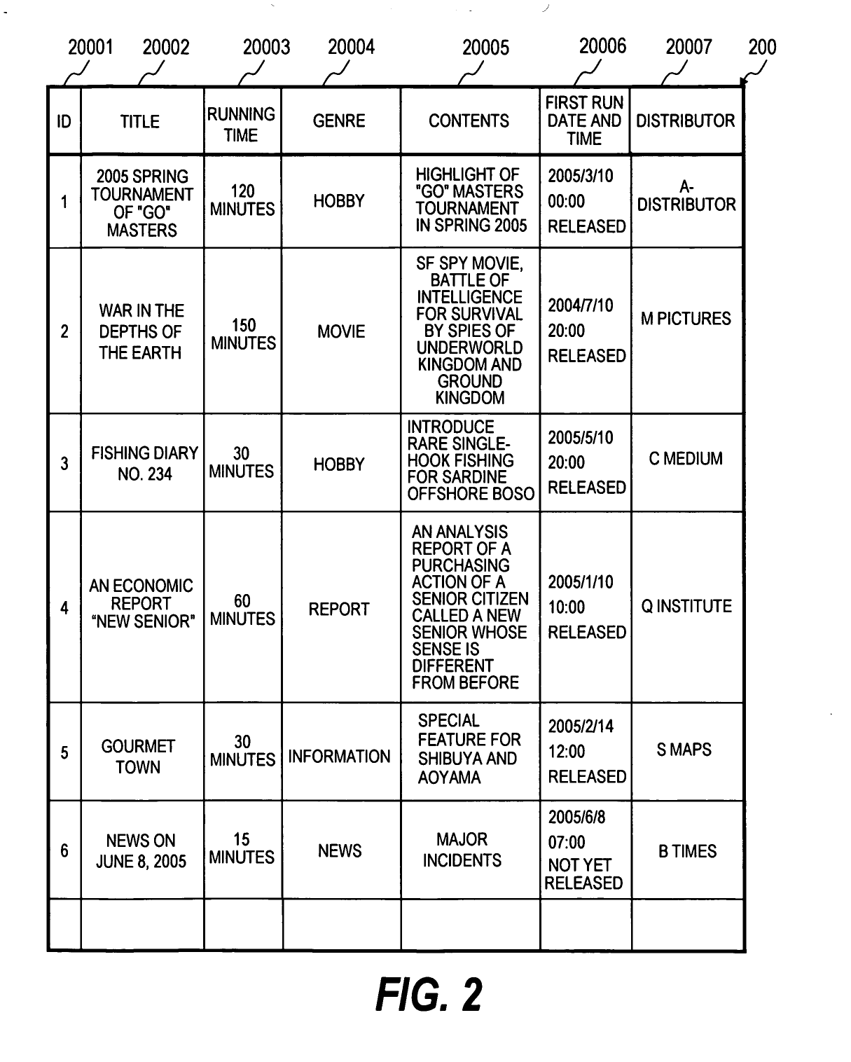

FIG. 2 is a table showing an example of a structure of the program list information 200 according to the embodiment of this invention.

The program list information 200 is stored in a storage device (not shown) of the program distribution server 101.

The program list information 200 includes a program ID 20001, a program title 20002, a running time 20003, a genre 20004, and contents 20005.

The program ID 20001 is a unique identifier of information of a program. The program title 20002 is a title of a program stored in the program distribution server 101. The running time 20003 is information indicating a running time of the program by a unit of minute. The genre 20004 is a genre of the program. The contents 2005 is meta information indicating contents of the program.

In the case of an on-demand service in which the program distribution server 101 delivers programs selected by users for each of the users, the program list information 200 further includes a first run date and time 20006 and a distributor 20007.

The first run date and time 20006 is information on a date and time when release of the program is started and includes information as to whether the program has been released or not yet released. The distributor 20007 is information on a distributor of the program.

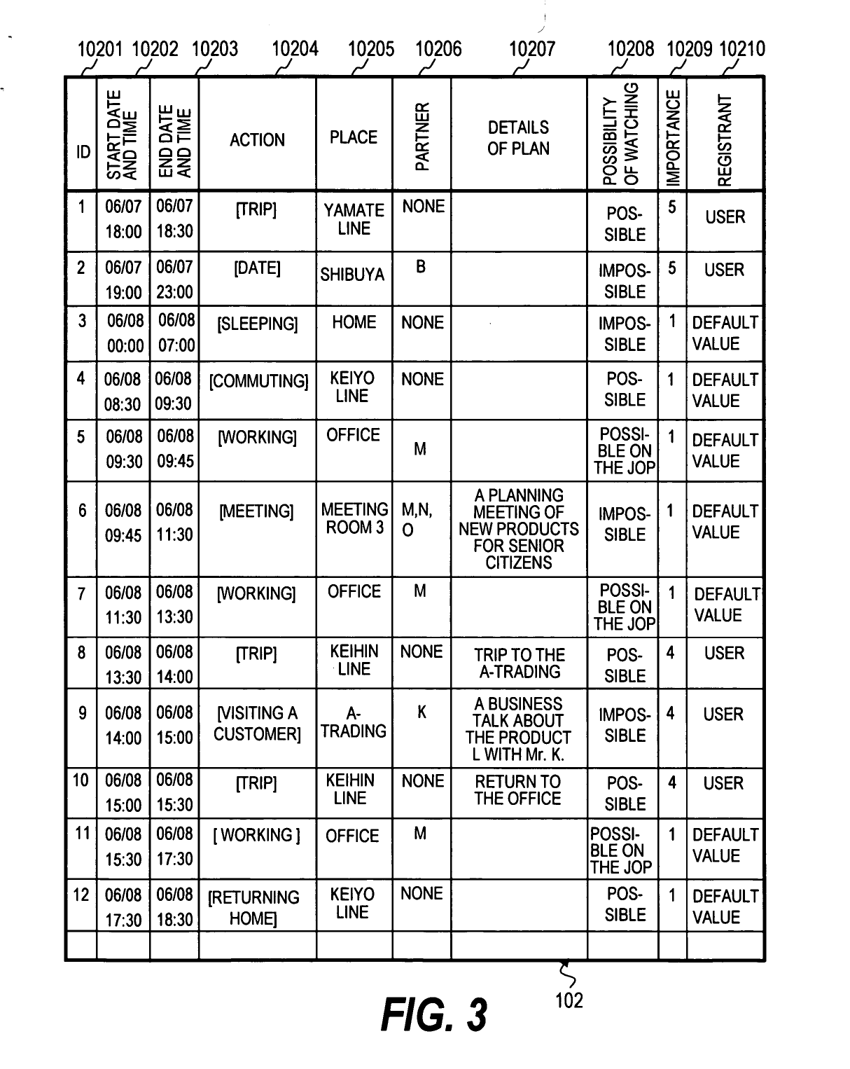

FIG. 3 is a table showing an example of a structure of a schedule of a user registered in the storing unit of the schedule book 102 according to the embodiment of this invention.

The schedule of the user includes a schedule ID 10201, a start date and time 10202, an end date and time 10203, an action 10204, a place 10205, a partner 10206, details of plan 10207, possibility of watching 10208, importance 10209, and a registrant 10210.

The schedule ID 10201 is a unique identifier of the schedule. The start date and time 10202 is a date and time when the schedule is started. The end date and time 10203 is a date and time when the schedule is ended.

The action 10204 is a classification item of the schedule set in advance. To be specific, the action 10204 is selected out of “commuting”, “working”, “returning home”, “trip”, “visiting a customer”, “meeting”, “date”, “shopping”, “program watching”, “sleeping”, and the like by the user or the computer system at the time of registration of the schedule.

The place 10205 is information on a place where the schedule is carried out. The place 10205 is registered by the user at the time of registration of the schedule. The partner 10206 is information on a person who is an object of the schedule. The partner 10206 is registered by the user at the time of registration of the schedule. When nothing is inputted in the partner 10206 by the user, the partner 10206 is represented as “none”. This is because, in some schedules, there is no partner depending on contents of the schedules. The details of plan 10207 is character information for explaining the schedule and inputted by the user at the time of registration of the schedule.

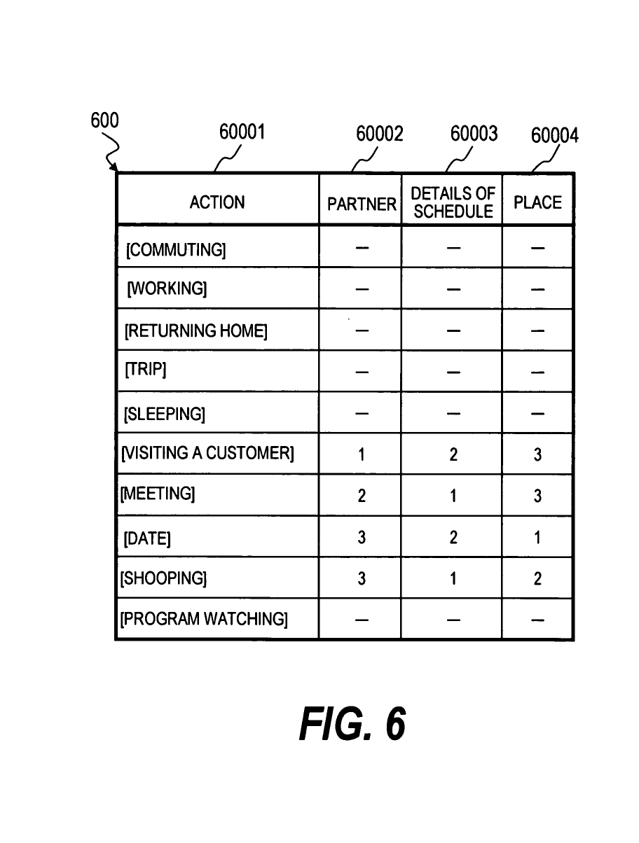

The possibility of watching 10208 is information indicating whether it is possible for the user to watch the program while the schedule is carried out, that is, from the start date and time until the end date and time of the schedule. To be specific, the possibility of watching 10208 is values of “possible”, “impossible”, and “possible on the job”. “Possible” means that it is possible for the user to watch a program while the schedule is carried out. “Impossible” means that it is impossible to watch a program while the schedule is carried out. “Possible on the job” means that it is possible for the user to watch a program related to a job while the schedule is carried out. The program related to a job is a program recommended for a schedule for which a relation 10302 of the address book 103 shown in FIG. 5 of the partner 10206 of the schedule of the program recommendation object to be described later is “official”. The possibility of watching 10208 is selected out of “possible”, “impossible”, and “possible on the job” by the user at the time of registration of the schedule.

The importance 10209 is a value indicating importance for the schedule. In this embodiment, the importance 10209 is indicated by numbers “1” to “5”. “1” indicates that the importance is the lowest and “5” indicates that the importance is the highest. Therefore, the importance 10209 increases in order from “1”.

The registrant 10210 is information indicating a cause of registration of the schedule. To be specific, the registrant 10210 is values of “user”, “default value”, and “program recommendation”. The “user” indicates that the schedule is registered by the user. The “default value” indicates that the schedule is automatically registered by a default schedule 400 to be described later. The “program recommendation” indicates that the schedule is registered by the program watching schedule planning unit 105. All of those items do not always have to be prepared. It is possible to use a schedule for this invention to be described later as long as the schedule includes information on a time frame in which the schedule is present.

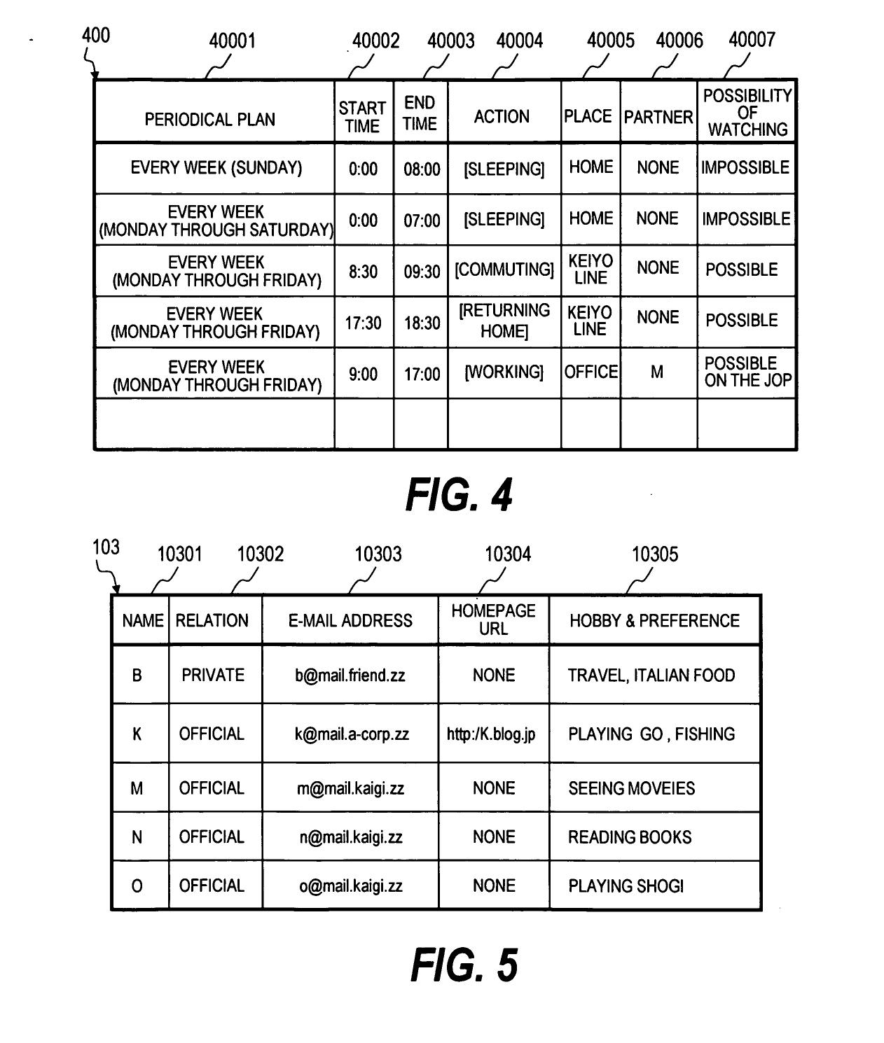

FIG. 4 is a table of an example of a structure of the default schedule 400 according to the embodiment of this invention.

The default schedule 400 is a schedule periodically repeated among the schedules registered in the schedule book 102 and is a schedule set in advance by the user. For example, the default schedule 400 is the same as weekly recording or daily recording of a home video.

The default schedule 400 includes a periodical plan 40001, a start time 40002, an end time 40003, an action 40004, a place 40005, a partner 40006, and possibility of watching 40007.

The periodical plan 40001 is information indicating a period of a schedule and registered by the user at the time of registration of the default schedule 400. The start time 40002 indicates a start time of the schedule to be repeated and is inputted by the user at the time of registration of the default schedule 400. The end time 40003 indicates an end time of the schedule to be repeated and is inputted by the user at the time of registration of the default schedule 400.

The action 40004 is a classification item of the schedule set in advance. To be specific, the action 40004 is selected out of “commuting”, “working”, “returning home”, “trip”, “visiting a customer”, “meeting”, “date”, “shopping”, “program watching”, “sleeping”, and the like by the user at the time of registration of the default schedule 400. The place 40005 is information on a place where the schedule is carried out. The place 40005 is inputted by the user at the time of registration of the default schedule 400. The partner 40006 is information on a person related to the schedule. The partner 40006 is inputted by the user at the time of registration of the default schedule 400. When nothing is inputted in the partner 40006 by the user, the partner 40006 is represented as “none”. This is because, in some schedules, there is no partner depending on contents of the schedules. The possibility of watching 40007 is information indicating whether it is possible for the user to watch the program while the schedule is carried out, that is, from the start date and time until the end date and time of the schedule. To be specific, the possibility of watching 40007 is values of “possible”, “impossible”, and “possible on the job”. “Possible” means that it is possible for the user to watch a program while the schedule is carried out. “Impossible” means that it is impossible to watch a program while the schedule is carried out. “Possible on the job” means that it is possible for the user to watch a program related to a job while the schedule is carried out. The program related to a job is a program recommended for a schedule for which the relation 10302 of the address book 103 shown in FIG. 5 of the partner 10206 of the schedule of the program recommendation object to be described later is “official”. The possibility of watching 40007 is selected out of “possible”, “impossible”, and “possible on the job” by the user at the time of registration of the default schedule 400.

It is possible to overwrite the schedule registered on the basis of the default schedule 400 with another schedule registered by the user. Alternatively, the user can delete the schedule registered on the basis of the default schedule 400.

FIG. 5 is a table showing an example of a structure of information on people related to the user registered in the storing unit of the address book 103 according to the embodiment of this invention.

The address book 103 includes a name 10301, a relation 10302, an e-mail address 10303, a home page URL 10304, and a hobby and preference 10305.

The name 10301 is information on a corporate name or a name registered in the address book 103.

The relation 10302 is information indicating a relation between the user and a registered partner. To be specific, the relation 10302 is values of “private”, “official”, and the like and selected from “private”, “official”, and the like by the user at the time of registration.

The e-mail address 10303 is an e-mail address of the registered partner.

The website URL 10304 is a URL of a website that provides information such as a blog of the registered partner.

The hobby & preference 10305 is information indicating a hobby or preference of the registered partner.

In this embodiment, the partner 10206 of the schedule book 102 and the name 10301 of the address book 103 are associated with each other. Thus, it is possible to refer to, from a schedule of the schedule book 102, the e-mail address 10303, the hobby & preference 10305, and the like of a partner who is an object of the schedule.

FIG. 6 is a table showing an example of a structure of a reference prioritization 600 according to the embodiment of this invention.

The reference prioritization 600 defines a reference priority for determining which item in the partner 10206, the details of plan 10207, or the place 10205 of the schedule book 102 is preferentially used for each item of an action 60001 to recommend a program.

The reference prioritization 600 includes the action 60001, a partner 60002, details of schedule 60003, and a place 60004.

The action 60001 corresponds to the action 10204 of the schedule book 102 and includes “commuting”, “working”, “returning home”, “trip”, “sleeping”, “visiting a customer”, “meeting”, “date”, “shopping”, and “program watching”.

The partner 60002 corresponds to the partner 10206 of the schedule book 102. The details of schedule 60003 corresponds to the details of plan 10207 of the schedule book 102. The place 60004 corresponds to the place 10205 of the schedule book 102.

For each item of the action 60001, values indicating priorities “1”, “2”, and “3” or “−” indicating that reference prioritization is not performed is set in the partner 60002, the details of schedule 60003, and the place 60004 in advance. Among the values indicating priorities, “1” indicates that a priority is the highest and “3” indicates that a priority is the lowest. Depending on an action, information contents with strong relationship found varies. For example, the information contents are a place for one action and a partner for another. Thus, by providing such the table, it is possible to recommend a program preferentially using information corresponding to an action.

In this embodiment, “commuting”, “working”, “returning home”, “trip”, “sleeping”, and “program watching” are actions for which reference prioritization is not performed. In other words, a schedule including those actions in the action 10204 of the schedule book 102 is a schedule not included in program recommendation objects. “Visiting a customer”, “meeting”, “date”, and “shopping” are actions for which reference prioritization is performed. In other words, a schedule including those actions in the actions 10204 of the schedule book 102 is a schedule included in program recommendation objects.

For example, when the action 60001 is “visiting a customer”, the partner 60002 is “1”, the details of schedule 60003 is “2”, and the place 60004 is “3”. Therefore, first, a program to be recommended is determined on the basis of the partner 10206 of the schedule book 102. When the partner 10206 is “none” or when a program cannot be recommended on the basis of the partner 10206, a program to be recommended is determined on the basis of the details of plan 10207. When the details of plan 10207 is not registered or when a program cannot be recommended on the basis of the details of plan 10207, a program to be recommended is determined on the basis of the place 10205.

To be specific, in the case of the schedule ID 9 in the schedule book 102 shown in FIG. 3, since the action 10204 is “visiting a customer”, a program is recommended with a top priority given to information of “K” of the partner 10206. When the partner 10206 is referred to for program recommendation, a program is recommended on the basis of information of “K” of the address book 103.

Next, the program recommendation unit 104 will be explained. The program recommendation unit 104 recommends a program from a schedule of the user on the basis of contents shown in FIG. 2 to FIG. 6.

In order to facilitate the explanation in this embodiment, as a method of recommending a program, a program including many words coinciding with words included in the program list information 200 (or may be words obtained by dividing the program list information 200 through the morphological analysis) and words of the place 10205 and the details of plan 10207 of the schedule book 102, the hobby & preference 10305 of the address book 103, and a website at a link destination of a URL of the website URL 10304 (or may be words obtained by dividing those items through the morphological analysis) is preferentially recommended. As a more specific method, there are many known methods such as the method disclosed in JP 2002-320159 A. Thus, explanations of the methods are omitted.

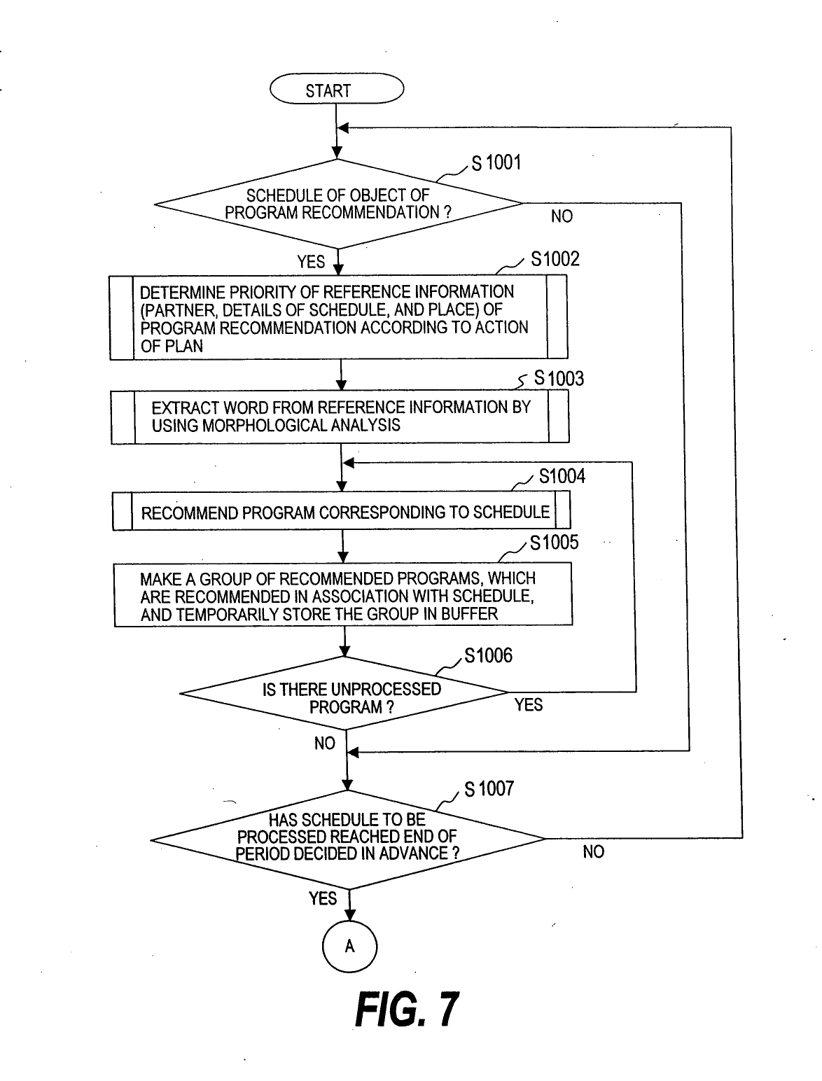

FIG. 7 is a flowchart of program recommendation processing executed by the program recommendation unit 104 according to the embodiment of this invention.

The program recommendation unit 104 extracts, with reference to the present date and time, schedules in a processing range time set in advance by the user in the schedule book 102. Since it is meaningless to recommend a program with respect to a schedule in far future, in this embodiment, the processing range time set in advance is one day (i.e., twenty-four hours).

First, the program recommendation unit 104 judges whether a schedule of a program recommendation object is present in schedules of the schedule book 102 within the processing range time set in advance by the user (S1001). In other words, the program recommendation unit 104 judges whether the actions (i.e., “visiting a customer”, “meeting”, “date”, and “shopping”) set as the program recommendation objects in the reference prioritization 600 are included in the action 10204 of the schedule book 102 in the processing range time.

When it is judged in Step S1001 that a schedule of a program recommendation object is not present in the schedules in the processing range time, the program recommendation unit 104 proceeds to Step S1007. Since a schedule of a program recommendation object is not present, the program recommendation unit 104 does not recommend a program.

On the other hand, when it is judged in Step S1001 that a schedule of a program recommendation object is included in the schedules in the processing range time, the program recommendation unit 104 acquires the schedule ID 10201 of the schedule of the program recommendation object and determines a reference priority on the basis of the reference prioritization 600 of the action 10204 of the schedule of the program recommendation object (S1002). When there are a plurality of schedule IDs 10201 acquired, the program recommendation unit 10204 executes the program recommendation processing in order from a schedule ID closest to the present date and time.

Next, the program recommendation unit 104 extracts words by applying the morphological analysis to the place 10205, the partner 10206, or the details of plan 10207 on the basis of priorities of the reference priority determined in Step S1002 (S1003).

First, the program recommendation unit 104 extracts a word by applying the morphological analysis to items, priorities of which in the reference priority are “1”. When a word cannot be extracted in the items, priorities of which in the reference priority are “1”, the program recommendation unit 104 extracts a word by applying the morphological analysis to items, priorities of which in the reference priority are “2”. When a word cannot be extracted in the items, priorities of which in the reference priority are “2”, the program recommendation unit 104 extracts a word by applying the morphological analysis to items, priorities of which in the reference priority are “3”.

The program recommendation unit 104 recommends a program for the schedule of the program recommendation object (S1004). To be specific, the program recommendation unit 104 searches for a program including the word extracted in Step S1003 from the program list information 200. When the word extracted in Step S1003 is included in at least one of the program title 20002 and the contents 20005 of the program list information 200, the program recommendation unit 104 acquires the program ID 20001. On the other hand, when the word extracted in Step S1003 is not included in the program title 20002 or the contents 20005 of the program list information 200, the program recommendation unit 104 does not acquire the program ID 20001. In other words, there is no program to be recommended for the schedules. When the first run date and time 20006 is “not yet released” at a date and time of the schedule of the program recommendation object, the program recommendation unit 104 does not acquire the program ID 20001. In other words, the program recommendation unit 104 does not recommend a program. Consequently, the user is capable of acquiring information on a program concerning the schedule.

The program recommendation unit 104 makes a group of the schedule ID 10201 acquired in Step S1002 and the program ID 20001 acquired in Step S1004 and store the group in a temporary buffer of the program recommendation apparatus (S1005). The schedule ID 10201 and the program ID 20001 stored in the temporary buffer are referred to as a group of recommended programs.

The program recommendation unit 104 judges, with respect to the schedule of the program recommendation object, whether an unprocessed program is present in the program list information 200 (S1006). When an unprocessed program is present, the program recommendation unit 104 returns to Step S1004. On the other hand, when an unprocessed program is not present, the program recommendation unit 104 proceeds to Step S1007.

The program recommendation unit 104 judges whether the program recommendation processing has been executed for all schedules of program recommendation objects in the processing range time (S1007). When it is judges that the program recommendation processing has been executed for all the schedules of the program recommendation objects, the program recommendation unit 104 sends groups of recommended programs stored in the temporary buffer of the program recommendation apparatus to the program watching schedule planning unit 105 and proceeds to program watching schedule planning processing. When there is a schedule of a program recommendation object for which the program recommendation processing has not been executed, the program recommendation unit 104 returns to Step S1001.

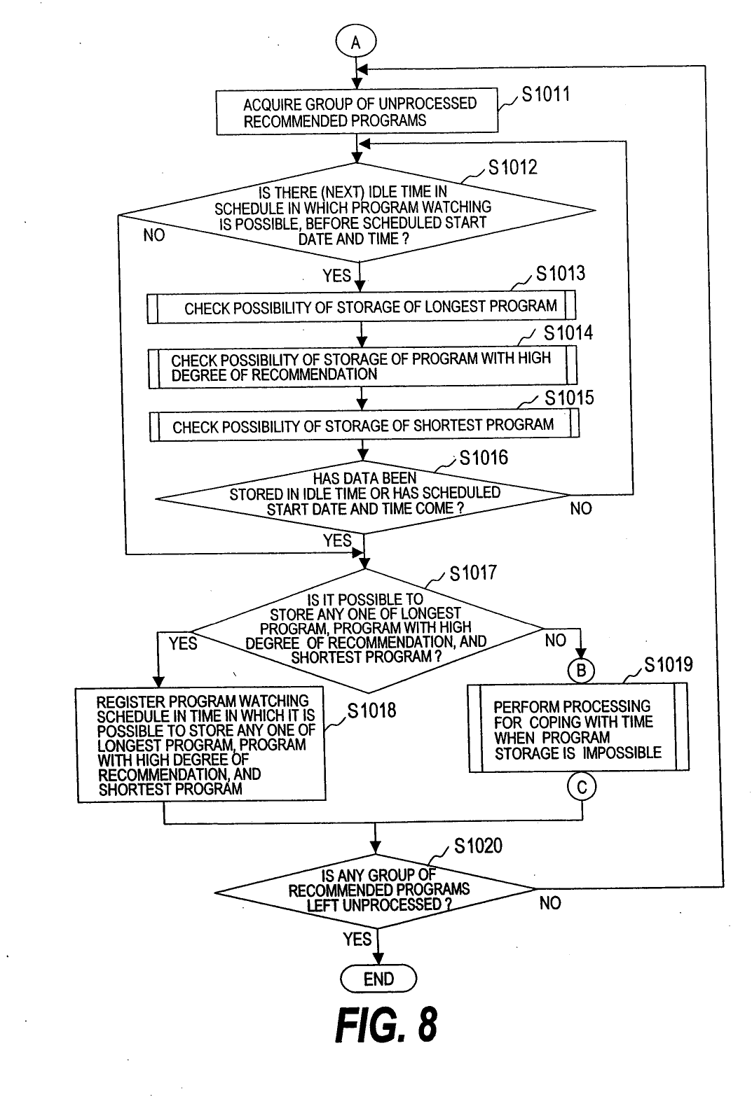

FIG. 8 is a flowchart of the program watching schedule planning processing executed by the program watching schedule planning unit 105 according to the embodiment of this invention.

The program watching schedule planning unit 105 sorts contents of a program recommendation result, that is, all the groups of recommended programs in the temporary buffer sent to the program watching schedule planning unit 105 in order from one with the highest importance 10209 of the schedules of the program recommendation objects. However, when the groups of recommended programs have the same importance 10209 of the schedules of the program recommendation objects, the program watching schedule planning unit 105 sorts the groups of recommended programs in an order of remaining times before the schedules. The program watching schedule planning unit 105 executes the program watching schedule planning processing for the groups of recommended programs in the order sorted (S1011). In other words, the program watching schedule planning unit 105 executes the program watching schedule planning processing for the groups of recommended programs in order from one with the highest importance 10209 of the schedules of the program recommendation objects. When the groups of recommended programs have the same importance 10209 of the schedules of the program recommendation objects, the program watching schedule planning unit 105 executes the program watching schedule planning processing in order from one with a shortest remaining time before the schedules of the program recommendation objects.

First, the program watching schedule planning unit 105 judges whether there is time in which it is possible for the user to watch a program recommended before a start date and time of the schedule of the program recommendation object from the schedule book 102 (S1012). The time in which it is possible for the user to watch the program means time in which it is possible for the user to watch the recommended program. To be specific, the time in which it is possible for the user to watch the programs means time in which the possibility of watching 10208 of the schedule book 102 is “possible” or “possible on the job” or not registered in the schedule book 102. In other words, the program watching schedule planning unit 105 searches for time that is before the schedule of the program recommendation object and in which it is possible for the user to watch the recommended program.

When time in which it is possible for the user to watch the program is present before the start date and time of the schedule of the program recommendation object, the program watching schedule planning unit 105 proceeds to Step S1013. On the other hand, time in which it is possible for the user to watch the program is not present before the start date and time of the schedule of the program recommendation object, the program watching schedule planning unit 105 proceeds to Step S1017.

However, when the possibility of watching 10208 is “possible on the job”, it is possible for the user to watch only a program related to a job. To be specific, the program watching schedule planning unit 105 accesses from the partner 10206 of the schedule of the program recommendation object to the relation 10302 of the partner of the address book 103. If the relation 10302 is “official”, in a schedule, the possibility of watching 10208 of which is “possible on the job”, it is possible for the user to watch a program recommended for the schedule of the program recommendation object. If the relation 10302 is not “official”, in a schedule, the possibility of watching 10208 of which is “possible on the job”, it is impossible to watch a program recommended for the schedule of the program recommendation object.

The program watching schedule planning unit 105 judges whether there is time in which it is possible for the user to watch the recommended program and in which it is possible to store the running time 20003 of a program with the longest running time 20003 from a schedule close to the present date and time (S1013). In other words, the program watching schedule planning unit 105 searches for time in which it is possible for the user to watch the recommended program and that is longer than the longest running time 20003. The program watching schedule planning unit 105 judges whether there is time in which it is possible for the user to watch a program with the highest recommendation level and in which it is possible to store the running time 20003 of the program (S1014). In other words, the program watching schedule planning unit 105 searches for time in which it is possible for the user to watch the recommended program and that is longer than the running time 20003 of the program with the highest recommendation level. The program watching schedule planning unit 105 judges whether there is time in which it is possible for the user to watch a program with the shortest running time 20003 and in which it is possible to store the running time 20003 of the program (S1015). In other words, the program watching schedule planning unit 105 searches for time in which it is possible for the user to watch the recommended program and that is longer than the shortest running time 20003. The program with the highest recommendation level in Step S1014 means a program in which the largest number of words extracted in Step S1003 of the program recommendation unit 104 are included in the program list information 200. When one program is not decided in Step S1013, Step S1014, and Step S1015, a program at the top in the program list information 200 is given priority.

When time in which it is possible for the user to watch the recommended program and that is longer than the running time of the program is found in the processing in each of Step S1013, Step S1014, and Step S1015, a schedule for watching programs is provisionally allocated to the time and search is not performed for time after the time.

When all the programs (i.e., the program with the longest running time, the program with the highest recommendation level, and the program with the shortest running time) are allocated to the time in which it is possible for the user to watch the recommended program in Step S1013, Step S1014, and Step S1015 or when the start date and time of the schedule has come, the program watching schedule planning unit 105 proceeds to Step S1017 (S1016). When all the programs (i.e., the program with the longest running time, the program with the highest recommendation level, and the program with the shortest running time) are not allocated to the time in which it is possible for the user to watch the recommended program and the start date and time of the schedule has not come, the program watching schedule planning unit 105 returns to Step S1012 and executes the search for time in which it is possible for the user to watch programs (S1016).

The program watching schedule planning unit 105 judges whether any one of the program with the longest running time, the program with the highest recommendation level, and the program with the shortest running time is allocated to time in which it is possible for the user to watch the program and that is longer than a running time of the program (S1017). In other words, the program watching schedule planning unit 105 judges whether any one of the program with the longest running time, the program with the highest recommendation level, and the program with the shortest running time is allocated to time in which it is possible to store the program and it is possible for the user to watch the program.

When any one of the program with the longest running time, the program with the highest recommendation level, and the program with the shortest running time is allocated to time in which it is possible for the user to watch the program and that is longer than a running time of the program, the program watching schedule planning unit 105 proceeds to Step S1018. On the other hand, when none of the program with the longest running time, the program with the highest recommendation level, and the program with the shortest running time is allocated to time in which it is possible for the user to watch the program and that is longer than a running time of the program, the program watching schedule planning unit 105 proceeds to processing for coping with time when it is impossible to store a program to be described later (S1019).

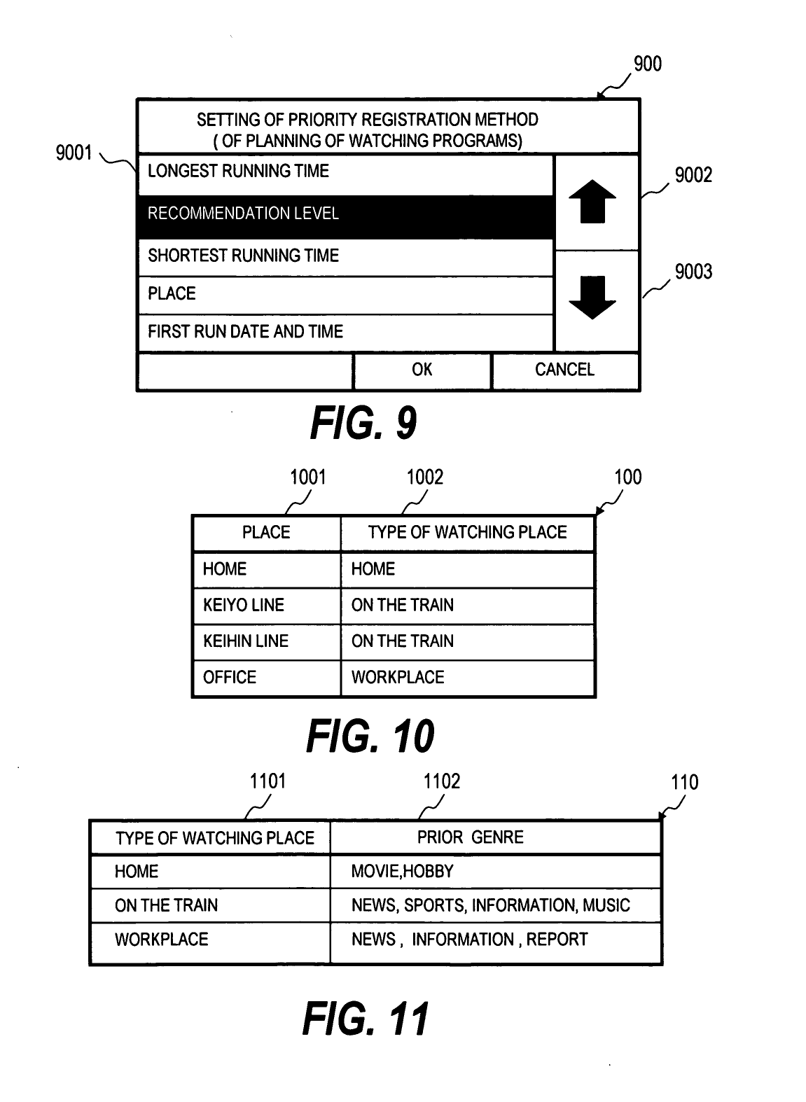

When any one of the program with the longest running time, the program with the highest recommendation level, and the program with the shortest running time is allocated to time in which it is possible for the user to watch the program and that is longer than a running time of the program in Step S1017, the program watching schedule planning unit 105 registers, on the basis of a priority of option setting by the user set by an option setting screen 900 of FIG. 9 described later, a schedule for watching the program in the time in which it is possible for the user to watch the program in the schedule book 102 (S1018). To be specific, the program watching schedule planning unit 105 registers a program watching schedule, the action 10204 of which is “program watching”, the registrant 10210 of which is “program recommendation”, and the details of plan 10207 of which is the schedule ID 10201 and the program ID 2001 of the group of recommended programs, in the schedule book 102 anew.

The program watching schedule planning unit 105 judges whether an unprocessed recommended program is present in the groups of recommended programs stored in the temporary buffer (S1020). When an unprocessed recommended program group is present, the program watching schedule planning unit 105 returns to Step S1011. When an unprocessed recommended program group is not present, the program watching schedule planning unit 105 ends the program watching schedule planning processing.

According to the constitution of this invention, the user can surely obtain related information prior to performing scheduling.

In the program recommendation method according to this embodiment, in Step S1018, it is possible to change, according to setting by the user, a priority indicating which of the program with the longest running time, the program with the highest recommendation level, and the program with the shortest running time should be preferentially registered in the schedule book 102.

FIG. 9 is a diagram showing an example of the option setting screen 900 according to the embodiment of this invention.

The option setting screen 900 includes a selection item 9001, an upward operation button 9002, and a downward operation button 9003.

In the selection item 9001, items of “longest running time”, “recommendation level”, “shortest running time”, “place”, and “first run data and time” are vertically arranged. Those items indicate programs preferentially registered when the program watching schedule planning unit 105 registers a program watching schedule in the schedule book 102. A priority is higher for an item arranged in a higher position and lower for an item arranged in a lower position.

The upward operation button 9002 interchanges a selected item with an item right above the selected item, or increases a priority of the selected item by one. The downward operation button 9003 interchanges a selected item with an item right below the selected item, or decreases a priority of the selected item by one. The upward operation button 9002 and the downward operation button 9003 interchange relative priorities of a selected item and other items.

In the example shown in FIG. 9, the item of “recommendation level” indicated by the black and white reversal is selected. When the user inputs the upward operation button 9002, positions of “recommendation level” and “longest running time” are interchanged and a priority of “recommendation level” is increased by one to be the highest priority. When the user inputs the downward operation button 9003, positions of “recommendation level” and “shortest running time” are interchanged and a priority of “recommendation level” is decreased by one.

The selection item 9001 includes “place” and “first run date and time”, which are not explained in the explanation of the program watching schedule planning unit 105. “Place” and “first run date and time” will be hereinafter explained with reference to FIG. 10 and FIG. 11.

FIG. 10 is a table of a place and type of watching place table 100 according to the embodiment of this invention.

The place and type of watching place table 100 includes a place 1001 and a type of watching place 1002.

The place 1001 corresponds to the place 10205 of a schedule registered in the schedule book 102.

The type of watching place 1002 is a type of a watching place corresponding to the place 10205 of a schedule registered in the schedule book 102.

FIG. 11 is a table of a type of watching place and prior genre table 110 according to the embodiment of this invention.

A type of watching place 1101 corresponds to the type of watching place 1002 of the place and type of watching place table 100. A prior genre 1102 is information indicating which genre 20004 of a program is given priority in association with the type of watching place 1101.

In “place”, the type of watching place 1002 is acquired according to the place and type of watching place table 100 on the basis of the place 10205 of the schedule book 102. The prior genre 1102 is acquired according to the type of watching place and prior genre table 110 on the basis of the type of watching place 1002. The running time 20003 of a program having the genre 20004 coinciding with the prior genre 1102 is acquired. It is judged whether there is time in which it is possible for the user to watch the program and in which it is possible to store the running time 20003 of the program. In other words, time in which it is possible for the user to watch the program and that is longer than the running time 20003 of the program is searched for.

In “first run date and time”, it is judged whether there is time in which it is possible for the user to watch a program, the first run date and time 20006 of the program list information 200 of which is closest to the present time, and in which it is possible to store the running time 20003 of the program. In other words, time in which it is possible for the user to watch the program and that is longer than the running time 20003 of the program is searched for.

Therefore, processing for searching for, on the basis of a program coinciding with a prior genre obtained on the basis of “place”, time in which it is possible for the user to watch the program and processing for searching for, on the basis of a program of “first run date and time”, time in which it is possible for the user to watch the program are processing corresponding to Step S1013 to Step S1015. It is possible to perform the processing by executing the processing between Step S1013 and Step S1015.

By giving priority to a program with “longest running time”, time longer than that of the program with the longest running time is registered as a program watching schedule. Thus, the time is time in which it is possible for the user to watch the program and that is longer than running times of all the recommended programs. Therefore, the user can watch an entire program selected according to preference of the user out of programs recommended in the time.

By giving priority to a program with “shortest running time”, a running time of the program with priority is the shortest. Thus, it is most likely that there are the largest number of times in which it is possible for the user to watch the program. Therefore, it is possible to flexibly cope with a change in a schedule of the user and, even if the user changes a watching schedule, it is possible to flexibly cope with the change. It is also possible to register a watching schedule of programs recommended for as many schedules to be program recommendation objects as possible. Even in a shortest running time of a program, the user can watch a program of a running time loner than that by fast forward or skip playing.

By giving priority to a program with “highest recommendation level”, a watching schedule of a program considered to match a schedule of a program recommendation object most is registered in the schedule book 102. As a result, it is likely that the entire schedule including the recommended program watching is optimized from the viewpoint of a user value.

By giving priority to a program coinciding with a prior genre obtained on the basis of “place”, a watching schedule of a program matching a watching place is registered. Thus, the user can efficiently understand the program. To be specific, when the watching place is “on the train”, a watching schedule of a program of a genre such as “news”, “sports”, “information”, or “music”, which is relatively easily understood, is registered in the schedule book 102 according to the type of watching place and prior genre table 110. When the watching place is “home” or “workplace” where the user is relaxed, a watching schedule of a program of a genre such as “movie” or “report”, which requires deep understanding, is registered in the schedule book 102 according to the type of watching place and prior genre table 110. Thus, understanding of the user is improved.

By giving priority to a program with “first run date and time”, a latest program has a higher value depending on a genre of a program. Thus, the user can preferentially watch information useful for the user and overall understanding of the user is improved.

As setting of a program to be given priority, when another item, for example, the genre 20004 of a program recommended by the program recommendation unit 104 is “news”, if a program with “first run date and time” is given priority, it is possible to register a program watching schedule more optimum for the user.

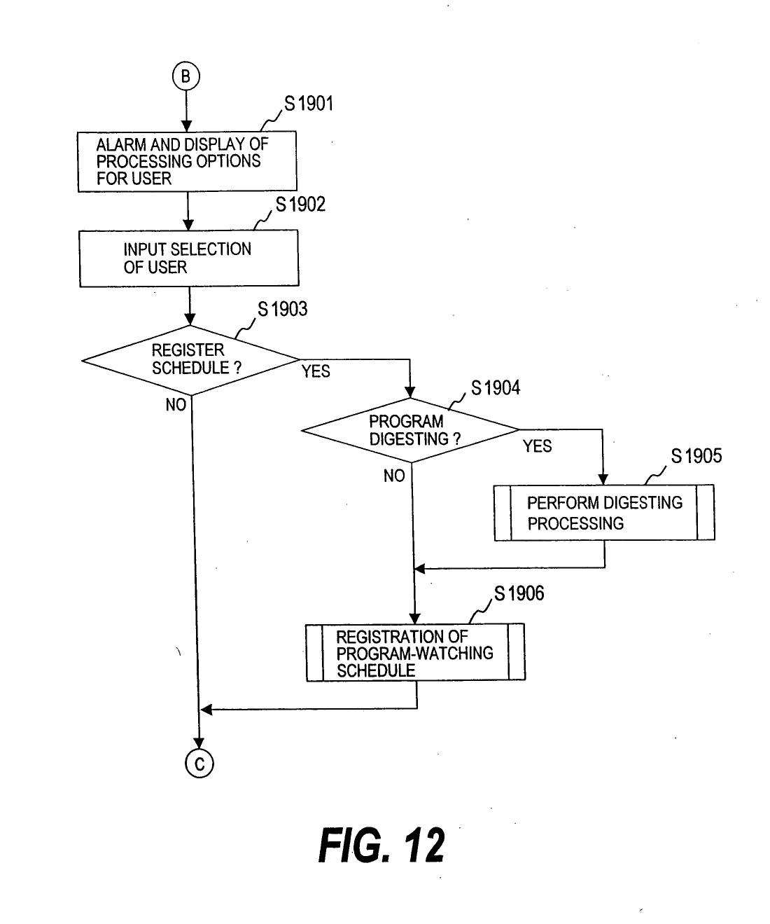

When it is judged in Step S1017 that it is impossible to store any of the programs, the program watching schedule planning unit 105 proceeds to the processing for coping with time when it is impossible to store a program (S1019). The processing for coping with time when it is impossible to store a program in Step S1019 will be hereinafter explained with reference to FIG. 12.

FIG. 12 is a flowchart of the processing for coping with time when it is impossible to store a program according to the embodiment of this invention.

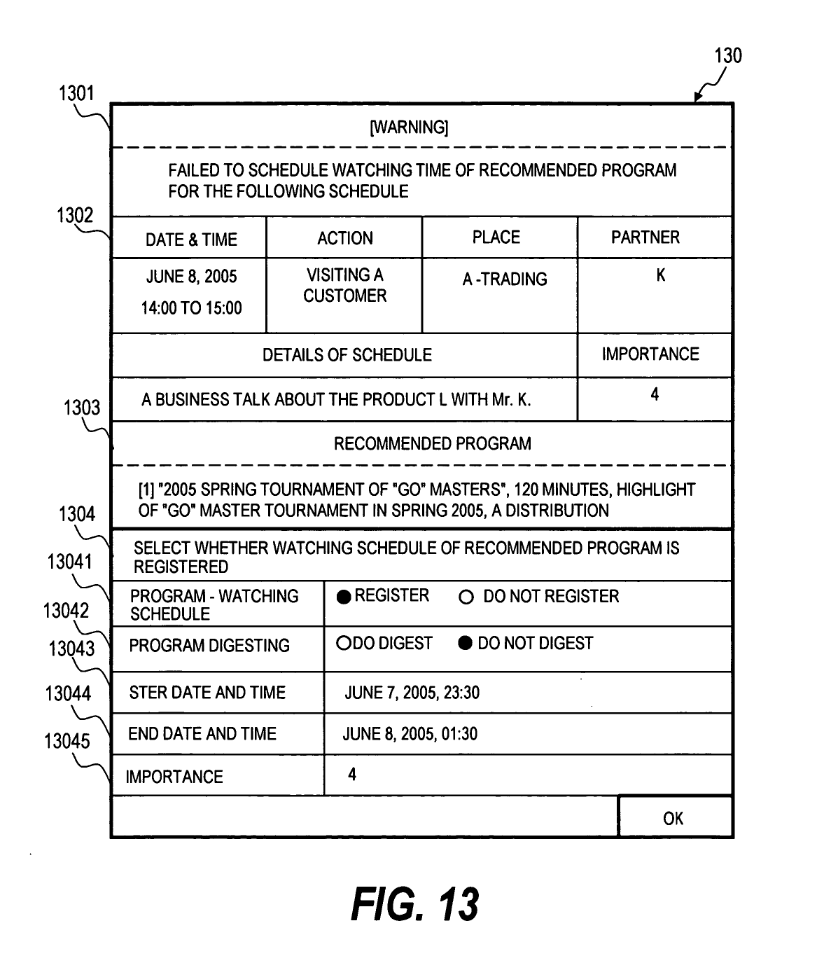

First, it is judged in Step S1017 that time in which it is possible for the user to watch a program with “longest running time”, “highest recommendation level”, “shortest running time”, or the like is not present before the schedule of the program recommendation object, the program watching schedule planning unit 105 displays an alarm screen 130 shown in FIG. 13 on the user interface unit 107 (S1901).

FIG. 13 is a diagram showing an example of the alarm screen 130 according to the embodiment of this invention.

The alarm screen 130 includes a warning sentence 1301, a schedule of program recommendation object 1302, details of schedule of recommended program 1303, and an input section 1304.

The warning sentence 1301 indicates that a program recommended for a schedule of a program recommendation object could not be registered in the schedule book 102.

The schedule of program recommendation object 1302 is information on a schedule to be an object of a recommended program and includes information such as “date and time”, “action”, “place”, “partner”, “details of schedule”, and “importance”. “Date and time” corresponds to the start date and time 10202 and the end date and time 10203 of the schedule book 102. “Action” corresponds to the action 10204. “Place” corresponds to the place 10205. “Partner” corresponds to the partner 10206. “Details of schedule” corresponds to the details of plan 10207. “Importance” corresponds to the importance 10209.

The details of schedule of recommended program 1303 includes information of the program title 20002, the running time 20003, the contents 20005, and the distributor 20007 of the program list information 200.

The input section 1304 includes a program watching schedule input section 13041, a program digesting input section 13042, a start date and time input section 13043, an end date and time input section 13044, and an importance input section 13045.

An indication of whether a watching schedule of a recommended program should be registered in the schedule book 102 is inputted in the program watching schedule input section 13041.

An indication of whether the recommended program should be subjected to program digesting is inputted in the program digesting input section 13042. The program digesting means digesting a program in order to reduce a running time of the program.

When the watching schedule of the recommended program is registered in the schedule book 102, a start date and time and an end date and time of the watching schedule are inputted in the start date and time input section 13043 and the end date and time input section 13044.

Importance of the program watching schedule is inputted in the importance 13045.

Returning to the explanation of the processing for coping with time when it is impossible to store a program of FIG. 12, when the alarm screen is displayed in Step S1901, the user inputs selection by the user in the input section 1304 (S1902).

The program watching schedule planning unit 105 judges whether the watching schedule of the recommended program should be registered in the schedule book 102 (S1903). To be specific, the program watching schedule planning unit 105 performs this judgment on the basis of whether the selection inputted in the program watching schedule input unit 13041 in Step S1902 is “register” or “do not register”.

When the watching schedule of the recommended program is registered, the program watching schedule planning unit 105 proceeds to Step S1904. When the watching schedule of the recommended program is not registered, the program watching schedule planning unit 105 proceeds to Step S1020.

When it is judged that the watching schedule of the recommended program is registered, the program watching schedule planning unit 105 judges whether the recommended program should be subjected to program digesting (S1904). To be specific, the program watching schedule planning unit 105 performs this judgment on the basis of whether the input in the program digesting input unit 13042 in Step S1902 is “do digest” or “do not digest”.

When it is judged that the recommended program is subjected to program digesting, the program watching schedule planning unit 105 proceeds to Step S1905. When it is judged that the recommended program is not subjected to program digesting, the program watching schedule planning unit 105 proceeds to Step S1906.

When it is judged that the recommended program is subjected to program digesting, the program watching schedule planning unit 105 executes program digesting processing on the recommended program (S1905). In the program digesting processing, the program watching schedule planning unit 105 digests the program such that the program is within the time between the time set in the start date and time input section 13043 and the time set in the end date and time input section 13044 inputted by the user in Step S1902. As a method of program digesting, various methods such as a method of deleting a time frame of a silent portion of a program and a method of deleting a time frame in which there is no change or few change in a video are adopted.

Since the program digesting processing requires a fixed time, the program digesting processing may be executed on the background according to the multitask. The program subjected to the program digesting processing is stored in the program distribution server 101 or the program playing unit 106 until the user watches the program.

As describe above, when time in which it is possible to store and watch the program recommended by the program recommendation unit 104 is not present before the schedule of the program recommendation object, a screen indicating to that effect is displayed. Thus, the user can recognize that the user cannot watch the recommended program and can change the schedule to create time in which it is possible for the user to watch the program. Therefore, it is possible to give the user an opportunity for judging whether the user should watch the program by even changing the schedule.

By displaying the input section 1304 including the program watching schedule input section 13041, the program digesting input section 13042, the start date and time input section 13043, the end date and time input section 13044, and the importance input section 13045 simultaneously with the alarm screen 130, when the user judges that the user watches the program by even changing the schedule, it is possible to register a program watching schedule according to a format of the input section 1304. Thus, the user does not have to directly operate the schedule book 102 and convenience for the user is further improved.

The program watching schedule planning unit 105 registers the watching schedule of the recommended program in the schedule book 102 (S1906). To be specific, the program watching schedule planning unit 105 registers a schedule for watching the recommended program in the date and time of the schedule book 102 of the start date and time input section 13043 and the end date and time input unit 13044 inputted in Step S1902.

When the recommended program is registered in the schedule book 102, the program watching schedule planning unit 105 proceeds to Step S1020.

The program recommendation processing executed by the program recommendation unit 104 and the program watching schedule planning processing executed by the program watching schedule planning unit 105 will be explained according to an example of the schedule book 102 shown in FIG. 3. It is assumed that the user instructed the computer system to perform program recommendation at 17:30 on Jun. 7, 2005.

First, in Step S1001, the program recommendation unit 104 extracts a schedule for one day (twenty-four hours) from the present date and time, 17:30 on Jun. 7, 2005. In other words, a schedule with the schedule ID 10201 from “1” to “11” is extracted.

Since actions of the schedule of the program recommendation object are “visiting a customer”, “meeting”, “date”, and “shopping”, the program recommendation unit 104 acquires a schedule ID 2, a schedule ID 6, and a schedule ID 9 and executes the program recommendation processing on the actions in order from “date” of the schedule ID 2 closest to the present date and time.

In the action 60001 of the reference prioritization 600, a reference priority of “date” is “3” for the partner 60002, “2” for the details of schedule 60003, and “1” for the place 60004. Thus, the program recommendation unit 104 extracts a word “Shibuya” of the place 10205 of the schedule ID 2 of the schedule book 102 (S1002 and S1003).

The program recommendation unit 104 searches for a program in which the extracted word “Shibuya” is included in the program title 20002 and the contents 20005 of the program list information 200. Since the word “Shibuya” is included in the contents 20005 of the program ID 5 and the first run date and time 20006 is “released”, the program recommendation unit 104 acquires the program ID 5. The program recommendation unit 104 stores the schedule ID 2 and the program ID 5 in the temporary buffer of the program recommendation apparatus (S1004 and S1005). In the program list information 200, a program including the word “Shibuya” is only the program ID 5 (S1006).

Since there is a schedule for which the program recommendation processing has not been executed yet, the program recommendation unit 104 returns to Step S1001 (S1007).

A schedule of a program recommendation object close to the present date and time is “meeting” with the schedule ID 6 (S1001).

In the action 60001 of the reference prioritization 600, a reference priority of “meeting” is “2” for the partner 60002, “1” for the details of schedule 60003, and “3” for the place 60004. Thus, when the program recommendation unit 104 extracts words by applying the morphological analysis to text information of the details of plan 10207 of the schedule ID 5 of the schedule book 102, words “senior citizen”, “new product”, “planning”, and “meeting” are extracted (S1002 and S1003).

The program recommendation unit 104 searches for a program in which at least one of the extracted words “senior citizen”, “new product”, “planning”, and “meeting” is included in the program title 20002 and the contents 20005 of the program list information 200. Since the word “senior citizen” is included in the contents 20005 of the program ID 4 and the first run date and time 20006 is “released”, the program recommendation unit 104 acquires the program ID 4. The program recommendation unit 104 stores the schedule ID 6 and the program ID 4 in the temporary buffer of the program recommendation apparatus (S1004 and S1005). In the program list information 200, a program including at least one of “senior citizen”, “new product”, “planning”, and “meeting” is only the program ID 4 (S1006).

Since there is a schedule for which the program recommendation processing has not been executed, the program recommendation unit 104 returns to Step S1001 again (S1007).

The schedule for which the program recommendation processing has not been executed is “visiting a customer” of the schedule ID 9 (S1001).

In the action 60001 of the reference prioritization 600, a reference priority of “visiting a customer” is “1” for the partner 60002, “2” for the details of schedule 60003, and “3” for the place 60004, the program recommendation unit 104 refers to the partner 10206 of the schedule ID 5 of the schedule book 102. Since the partner 10206 of the schedule book 102 and the name 10301 of the address book 103 are associated with each other and “K” is registered in the partner 10206, the program recommendation unit 104 searches for “K” in the name 10301 of the address book 103. Since “K” is registered in the address book 103 and the hobby & preference 10305 is registered as “playing go and fishing”, when the program recommendation unit 104 extracts words, words “playing go” and “fishing” are extracted (S1002 and S1003).

The program recommendation unit 104 searches for a program in which at least one of the extracted words “playing go” and “fishing” is included in the program title 20002 and the contents 20005 of the program list information. Since the word “go” is included in the program title 20002 and the contents 20005 of the program ID 1, the word “fishing” is included in the program title 20002 and the contents 20005 of the program ID 3, and the first run date and time 20006 is “released” for both programs with the program ID 1 and the program ID 3, the program recommendation unit 104 acquires the program ID 1 and the program ID 3. The program recommendation unit 104 stores the schedule ID 9, the program ID 1, and the program ID 3 in the temporary buffer of the program recommendation apparatus (S1004 and S1005). In the program list information 200, programs including at least one of “go” and “fishing” are the programs with the program ID 1 and the program ID 3 (S1006).

Since there is no schedule of a program recommendation object in the processing range time, the program recommendation unit 104 sends the groups of recommended programs stored in the temporary buffer of the program recommendation apparatus to the program watching schedule planning unit 105 and ends the program recommendation processing (S1007).

All the groups of recommended programs in this case are (the schedule ID 2 and the program ID 5), (the schedule ID 6 and the program ID 4), and (the schedule ID 9, the program ID 1, and the program ID 3).

All the groups of recommended programs are passed to the program watching schedule planning unit 105 and sorted in an order of importance of the schedules. Since importance of the schedule ID 2 is “5”, importance of the schedule ID 6 is “1”, and importance of the schedule ID 9 is “4”, the groups of recommended programs are sorted in an order of the schedule ID 2, the schedule ID 9, and the schedule ID 6. Therefore, first, the program watching schedule planning processing is executed on (the schedule ID 2 and the program ID 5) (S1011).

Since the relation 10302 of “B” of the partner 10206 of the schedule ID 2 is “private”, it is impossible to watch a schedule, the possibility of watching 10208 of which is “possible on the job”.

When the program watching schedule planning unit 105 searches for time in which it is possible for the user to watch the program until a start date and time (19:00 on June 7) of the schedule ID 2, time of 18:30 to 19:00 in which a schedule is not registered in the schedule ID 1 and the schedule book 102 corresponds to the time (S1012).

Since a recommended program of the schedule ID 2 is only the program ID 5, in the processing from Step S1013 to Step S1015 and processing for judging “place” and “first run date and time”, time in which it is possible for the user to watch the program ID 5 and that is longer than the running time (i.e., 30 minutes) of the program ID 5 is searched for until a start date and time of the schedule of the program recommendation object. Then, since the schedule ID 1 is 30 minutes when the start date and time 10202 is subtracted from the end date and time 10203, it is possible to store the program ID 5 and a schedule for watching the program ID 5 is provisionally allocated to the schedule ID 1 (S1013, S1014, and S1015).

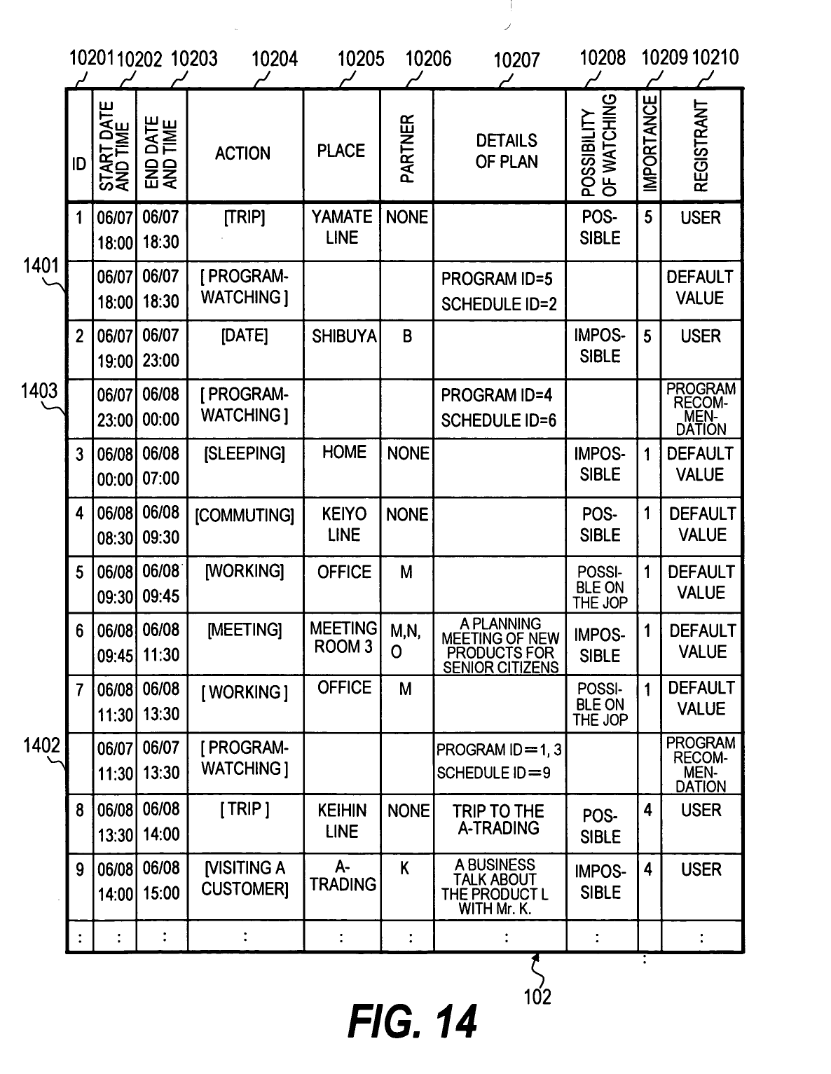

Therefore, since a schedule for watching the program ID 5 is provisionally allocated to the schedule ID 1, the program watching schedule planning unit 105 ends the search for time in which it is possible for the user to watch the program (S1016). Since the program ID 5 can be stored in the schedule ID 1 (S1017), the program watching schedule planning unit 105 registers the schedule for watching the program ID 5 in the schedule book 102 (S1018). In registering the watching schedule of the program ID 5 in the schedule book 102, as indicated by a row of 1401 shown in FIG. 14, the program watching schedule planning unit 105 registers, in the schedule book 102, a new schedule, the action 10204 of which is “program watching” and the registrant 10210 of which is “program recommendation”, and in which the program ID 5 and the schedule ID 2 are registered in the details of plan 10207.

In Step S1020, the program watching schedule planning unit 105 judges whether an unprocessed recommended program is present in the groups of recommended programs. Since (the schedule ID 9, the program ID 1, and the program ID 3) and (the schedule ID 6 and the program ID 4) are unprocessed, the program watching schedule planning unit 105 returns to Step S1011.

The program watching schedule planning unit 105 executes the program watching schedule planning processing for the group of recommended programs (the schedule ID 9, the program ID 1, and the program ID 3) next (S1011).

Since the relation 10302 of “K” of the partner 10206 of the schedule ID 9 is “official”, even in schedules (the schedule ID 5 and the schedule ID 7), the possibility of watching 10208 of which is “possible on the job”, it is possible for the user to watch a program.

When the program watching schedule planning unit 105 searches for time in which it is possible for the user to watch a program until a start date and time (14:00 on June 8) of the schedule ID 9, 18:30 to 19:00 and 23:00 to 0:00 on June 7, 7:00 to 8:30 on June 8, the schedule ID 4, the schedule ID 5, the schedule ID 7, and the schedule ID 8 correspond to the time (S1012).

In the processing for judging a program with a longest running time (S1013), since the program with the longest running time is 120 minutes in the program ID 1, the program watching schedule planning unit 105 judges whether the time in which it is possible for the user to watch a program is longer than the running time of the program ID 1, that is, whether it is possible to store the program ID 1 in the time. Since length of time in 18:30 to 19:00 on June 7 is 30 minutes, it is impossible to store the program ID 1. Since length of time in 23:00 to 0:00 on June 7 is 60 minutes, it is impossible to store the program ID 1. Since length of time in 7:00 to 8:30 on June 8 is 90 minutes, it is impossible to store the program ID 1. Since length of time in the schedule ID 4 is 60 minutes, it is impossible to store the program ID 1. Since length of time in the schedule ID 5 is 15 minutes, it is impossible to store the program ID 1. Since length of time in the schedule ID 7 is 120 minutes it is possible to store the program ID 1 and, the schedule for watching the program ID 1 is provisionally allocated to the schedule ID 7. It is not judged for time after this whether it is possible to store a program.

In the processing for judging a program with a highest recommendation level (S1014), there is only one phrase “playing go” in the program ID 1 and there is only one word “fishing” in the program ID 3. Thus, recommendation levels of the program ID 1 and the program ID 3 are equal. When the recommendation levels are equal, since a program in a higher position is given priority in the program list information 200, the program ID 1 is given priority. Therefore, as in the case of the program with the longest program playing time in Step S1013, the program watching schedule planning unit 105 judges whether it is possible to store the program ID 1 and a schedule for watching the program ID 1 is provisionally allocated to the schedule ID 7. It is not judged for time after this whether it is possible to store a program.

In the processing for judging a program with a shortest running time (S1012), a program with a shortest running time is the program ID 3 and length of the program ID 3 is 30 minutes. The program watching schedule planning unit 105 judges whether the time in which it is possible for the user to watch a program is longer than the running time of the program ID 3, that is, whether it is possible to store the program ID 3 in the time. Since length of time in 18:30 to 19:00 on June 7 is 30 minutes, it is possible to store the program ID 3. A schedule for watching the program ID 3 is provisionally allocated to the time. It is not judged for time after this whether it is possible to store a program.

In the processing for judging a program coinciding with a prior genre acquired on the basis of “place”, the genre 20004 of the program ID 1 and the program ID 3 is “hobby”. Check processing is performed from 18:30 to 19:00 on June 7 closest to the present date and time. Since 18:30 to 19:00 on June 7 is time in which a schedule is not registered in the schedule book 102, it is impossible to acquire the prior genre 1102 from the place and type of watching place table 100 and the type of watching place and prior genre table 110. Therefore, since a program that can be stored in 18:30 to 19:00 is the program ID 1, a schedule for watching the program ID 3 is provisionally allocated to the time. It is not judged for time after this whether it is possible to store a program.

In the processing for judging a first run date and time, a first run date and time of the program ID 1 is 00:00 on Mar. 10, 2005 and a first run date and time of the program ID 3 is 20:00 on May 10, 2005. A start date and time of the schedule ID 9, which is a schedule of a program recommendation object, is 14:00 on Jun. 8, 2005. Therefore, the program watching schedule planning unit 105 judges whether it is possible to store the program ID 3 with the first run date and time closes to the start date and time of the schedule ID 9 in the schedules. Since length of time in 18:30 to 19:00 on June 7 is 30 minutes, it is possible to store the program ID 3 in the time. A schedule for watching the program ID 3 is provisionally allocated to the time. It is not judged for time after this whether it is possible to store a program.

Therefore, since the recommended program is within the time in which it is possible for the user to watch a program, the program watching schedule planning unit 105 ends the search for a time in which it is possible for the user to watch a program (S1016). Since there is a schedule in which it is possible to store a program given priority in the processing in Step S1013, Step S1014, and Step S1015 and in the processing for judging “place” and “first run data and time”, the program watching schedule planning unit 105 proceeds to Step S1018 (S1017).

In this embodiment, sine a priority of program watching schedule registration that can be set by the user is “longest running time”, the program watching schedule planning unit 105 registers a schedule for watching the program ID 1 and the program ID 3 in the schedule ID 7 in the schedule book 102 (S1018). In registering the watching schedule of the program ID 5 in the schedule book 102, as indicated by a row of 1402 shown in FIG. 14, the program watching schedule planning unit 105 registers, in the schedule book 102, a new schedule, the action 10204 of which is “program watching” and the registrant 10210 of which is “program recommendation”, and in which the program ID 1, the program ID 3, and the schedule ID 9 are registered in the details of plan 10207.

When it is judged in Step S1020 whether there is an unprocessed recommended program in the groups of recommended programs, since (the schedule ID 6 and the program ID 4) is unprocessed, the program watching schedule planning unit 105 returns to Step S1011.

The program watching schedule planning unit 105 executes the program watching schedule planning processing for the group of recommended programs (the schedule ID 6 and the program ID 4) next (S1011).

Since the relation 10302 of “M”, “N”, and “O” of the partner 10206 of the schedule ID 6 is “official”, even in a schedule (the schedule ID 5 and the schedule ID 7), the possibility of watching 10208 of which is “possible on the job”, it is possible for the user to watch a program.

When the program watching schedule planning unit 105 searches for time in which it is possible for the user to watch a program until a start date and time (i.e., 09:45 on June 8) of the schedule ID 6, 18:30 to 19:00 and 23:00 to 0:00 on June 7 and 7:00 to 8:30 on June 8, the schedule ID 4, and the schedule ID 5 correspond to the time (S1012).

In the processing in Step S1013, Step S1014, and Step S1015 and the processing for judging “place” and “first run date and time”, since a recommended program is only the program ID 4, an explanation of the processing is omitted. A running time of the program ID 4 is 60 minutes. Since length of time in 18:30 to 19:00 on June 6 is 30 minutes, it is impossible to store the program ID 4. Since length of time in 23:00 to 0:00 on June 7 is 60 minutes, it is possible to store the program ID 4. A schedule for watching the program ID 4 is provisionally allocated to the time. It is not judged for time after this whether it is possible to store a program.

Therefore, since all the recommended programs are within the time in which it is possible for the user to watch a program, the program watching schedule planning unit 105 ends the search for time in which it is possible for the user to watch a program (S1016). Since there is a schedule in which it is possible to store a program given priority in the processing in Step S1013, Step S1014, and Step S1015 and the processing for judging “place” and “first run date and time”, the program watching schedule planning unit 105 proceeds to Step S1018 (S1017). In this embodiment, since a priority of program watching schedule registration that can be set by the user is “longest running time”, the program watching schedule planning unit 105 registers a schedule for watching the program ID 4 in 23:00 to 0:00 on June 7 in the schedule book 102 (S1018). In registering the watching schedule of the program ID 4 in the schedule book 102, as indicated by a row of 1403 shown in FIG. 14, the program watching schedule planning unit 105 registers, in the schedule book 102, a new schedule, the action 10204 of which is “program watching” and the registrant 10210 of which is “program recommendation”, and in which the program ID 1 and the program ID 6 are registered in the details of plan 10207.

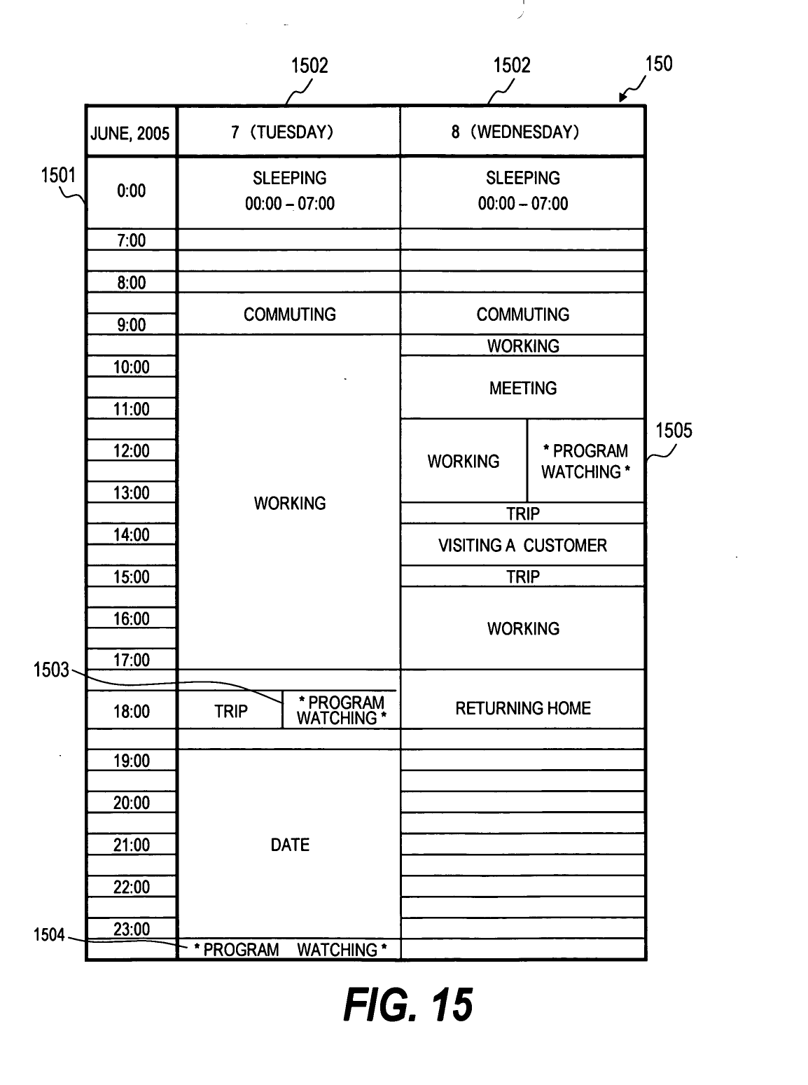

FIG. 15 is a diagram showing an example of a schematic display screen 150 for a schedule of the schedule book 102.

The schematic display screen 150 for a schedule is displayed when the user refers to the schedule book 102 of a result obtained by executing the processing described above.

On the schematic display screen 150 for a schedule, time 1501, year, month, and day 1502, and information on various schedules are displayed.

It is possible to distinguish a schedule registered by the program watching schedule planning unit 105 from a schedule registered by the user by changing display colors and/or inserting a conspicuous sign.

In the example shown in FIG. 15, a conspicuous sign “*” is inserted before and after characters “program watching” in schedules 1503, 1504, and 1505 registered by the program watching schedule planning unit 105.

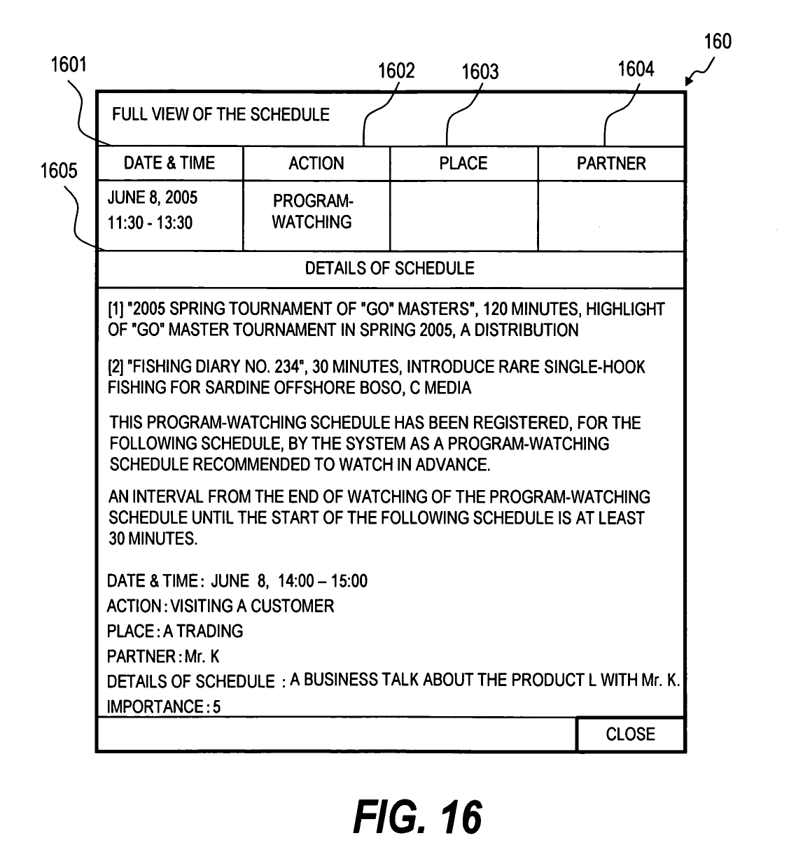

FIG. 16 is an example of a detailed display screen 160 for a schedule registered by the program watching schedule planning unit 105.

To be specific, the detailed display screen 160 for a schedule is displayed on the basis of information of a program watching schedule registered by the program watching schedule planning unit 105 when a schedule registered by the program watching schedule planning unit 105 on the schematic display screen 150 for a schedule is instructed.

The detailed display screen 160 for a schedule includes information of a date and time 1601, an action 1602, a place 1603, a partner 1604, and details of schedule 1605.

The date and time 1601 is based on the start date and time 10202 and the end date and time 10203 of the schedule book 102 of the schedule and is information indicating a start date and time and an end date and time of the schedule. The action 1602 corresponds to the action 10204 of the schedule book 102 of the schedule. The place 1603 corresponds to the place 10205 of the schedule book 102 of the schedule. The partner 1604 corresponds to the partner 10206 of the schedule book 102 of the schedule.

The details of schedule 1605 includes a recommended program information section and a program recommendation object schedule information section.

In the recommended program information unit, information of the program title 20002, the running time 20003, the contents 20005, and the distributor 20007 of the program list information 200 of a program recommended by the program recommendation unit 104 is displayed.

In the program recommendation object schedule information unit, information of a date and time, an action, a place, a partner, details of schedule, and importance of a schedule of a program recommendation object is displayed.

If the detailed display screen 160 for a schedule is created using the HTML and a script, it is possible to start playing of a program through the program playing unit 106 simply by clicking a program title of the recommended program information section.

By displaying details of the schedule of the program recommendation object, the user can grasp a reason of a program watching schedule, can easily judge whether the user should actually watch a recommended program, and can watch a program while being conscious of the schedule of the program recommendation object. Thus, a value of program watching is improved.

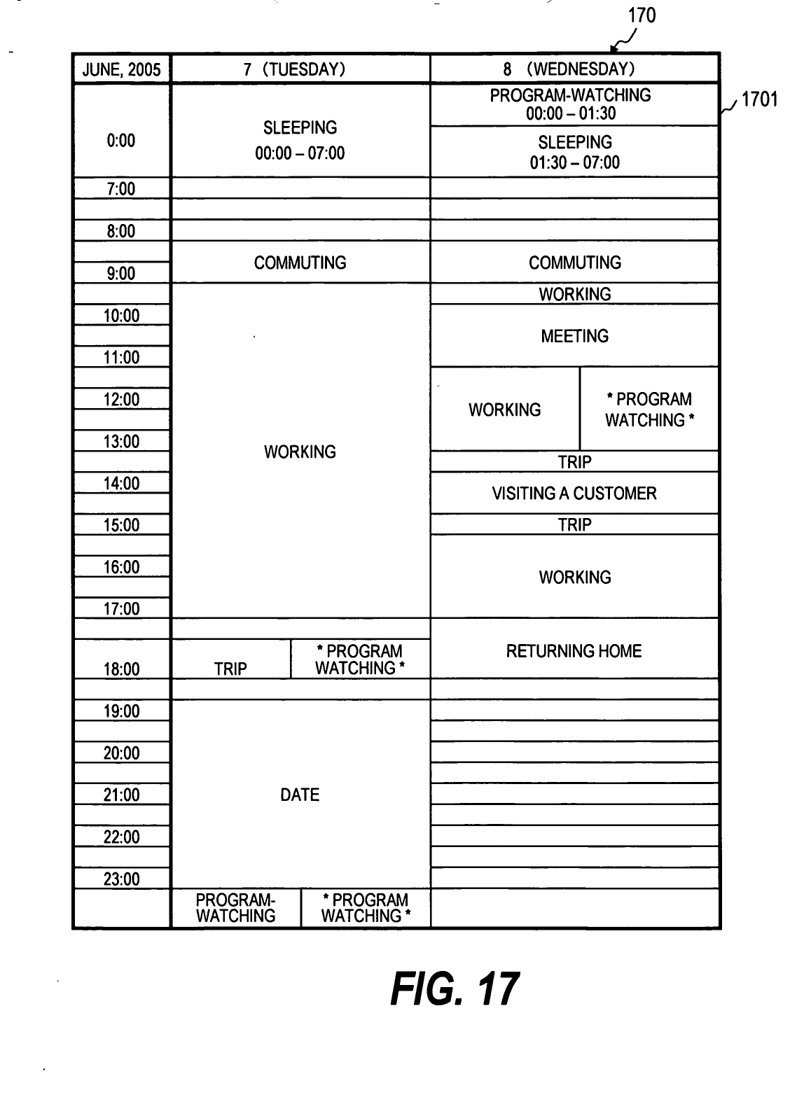

FIG. 17 is a diagram showing an example of the schematic display screen for a schedule of the schedule book 102.

In the example shown in FIG. 17, in the processing for coping with time when it is impossible to store a program (S1019) executed when it is judged in Step S1017 of the program watching schedule planning processing that it is impossible to store the recommended program, a so-called sleeping time, the action 10204 of which is “sleeping”, is changed to a watching schedule time of the recommended program.

As shown in 1701 of FIG. 17, “sleeping” is usually registered as 00:00 to 07:00 by the default schedule 400. However, “sleeping” is changed to 01:30 to 07:00 and 00:00 to 01:30 is allocated to “program watching”.

Since “program watching” is a schedule registered by the user, the processing for changing a display color and inserting a conspicuous sign is not applied to “program watching”.

In this embodiment, in searching for a time in which it is possible for the user to watch a program (Step S1013, Step S1014, Step S1015, etc.), it is judged, on the basis of a running time of a recommended program, whether it is possible to store the program. However, time serving as a reference for judging whether it is possible to store a program may be changed according to the importance 10209 of a schedule of a program recommendation object.

When the importance 10209 of the schedule of the program recommendation object is high, a reference time is set to 1.5 times as long as a running time. When the importance 10209 of the schedule of the program recommendation object is low, a reference time is set to 0.7 times as long as the running time. In general, in watching a program recommended for a schedule with high importance 10209, it is highly likely that the user stops playing in the middle or repeats a part of the program in order to deepen understanding. Thus, time in which it is possible for the user to watch a program may be set longer than a running time of the program. Further, in watching a program recommended for a schedule with low importance 10209, it is highly likely that the user skips playing in the middle of program watching. Thus, time in which it is possible for the user to watch a program may be set shorter than a running time of the program. Consequently, a value of a schedule including program watching for the user is further improved.

If the program recommendation method according to this invention is used, the user can watch a program related to a schedule prior to the schedule. This makes it easy to further enrich a schedule by increasing knowledge in advance and appeal the user himself/herself in a meeting and a business talk.

It is possible to apply the program recommendation method according to this invention to video apparatuses for home use such as a DVD recorder and a television, a personal computer with a television function, information apparatuses such as a PDA and a cellular phone, a set top box for playing programs distributed through a network, and the like.

While the present invention has been described in detail and pictorially in the accompanying drawings, the present invention is not limited to such detail but covers various obvious modifications and equivalent arrangements, which fall within the purview of the appended claims.

What is claimed is:

1. A program recommendation method for a computer system including a program distribution server in which program information is stored, a schedule storing unit for storing a schedule of a user, and a program recommendation unit for recommending programs from the program information, comprising the steps of:
recommending, in case of which a schedule to be an object of program recommendation is stored in the schedule storing unit, at least a program from the program information stored in the program distribution server based on the stored schedule;
searching for a period that is before a start time of the schedule of an object of program recommendation and in which it is possible for the user to watch the programs recommended by the program recommendation unit; and
registering a program watching schedule, which is a schedule for watching programs recommended in the searched period, in the schedule storing unit.

2. The program recommendation method according to claim 1, wherein the step of searching for a period in which it is possible for the user to watch the recommended programs and which is longer than a playing length of a longest program among the recommended programs.

3. The program recommendation method according to claim 1, wherein the step of searching for a period in which it is possible for the user to watch the recommended programs and which is longer than a playing length of a shortest program among the recommended programs.

4. The program recommendation method according to claim 1, wherein the step of searching for a period in which it is possible for the user to watch the recommended programs and which is longer than a playing length of a program having high coincidence with the program recommendation object schedule.

5. The program recommendation method according to claim 1, wherein the computer system includes a user interface that displays at least a schedule of the user,
the program recommendation method further comprising the step of displaying the program watching schedule distinguishing from a schedule registered by the user on the user interface.

6. The program recommendation method according to claim 1, wherein the computer system includes a user interface that displays at least a schedule of the user,
the program recommendation method further comprising the step of notifying, when there is not a period in which it is possible for the user to watch the recommended programs before a start time of the schedule, the user that the period in which it is possible for the user to watch the recommended programs is not present before the start time of the schedule of an object of program recommendation.

7. A program recommendation apparatus having a processor for performing arithmetic processing and a memory connected to the processor, comprising:
a program recommendation unit for recommending, in case of which a schedule to be an object of a program recommendation is stored in a schedule storing unit, at least a program from program information stored in a program distribution server based on the stored schedule; and
a program watching schedule planning unit for searching for a period that is before a start time of the schedule of an object of program recommendation and in which it is possible for the user to watch recommended programs by the program recommending unit and registers, in the schedule storing unit, a program watching schedule, which is a schedule for watching programs recommended by the program recommendation unit in the searched period.

8. The program recommendation apparatus according to claim 7, wherein the program watching schedule planning unit searches a period in which it is possible for the user to watch the programs recommended by the program recommendation unit and which is longer than a playing length of a longest program among the recommended programs.

9. The program recommendation apparatus according to claim 7, wherein the program watching schedule planning unit searches a period in which it is possible for the user to watch the programs recommended by the program recommendation unit and which is longer than a playing length of a shortest program among the recommended programs.

10. The program recommendation apparatus according to claim 7, wherein the program watching schedule planning unit searches a period in which it is possible for the user to watch the programs recommended by the program recommendation unit and which is longer than a playing length of a program having high coincidence with the schedule of an object of program recommendation.

11. The program recommendation apparatus according to claim 7, wherein the program recommendation apparatus causes a user interface that displays at least a schedule of the user to displaying the program watching schedule distinguishing from a schedule registered by the user on the user interface.

12. The program recommendation apparatus according to claim 7, wherein the program watching schedule planning unit notifies, when there is not a period in which it is possible for the user to watch the recommended programs before a start time of the schedule, the user that the period in which it is possible for the user to watch the recommended programs is not present before the start time of the schedule.

13. The program recommendation apparatus according to claim 7, wherein the program recommendation unit recommends a program concerning at least any one of a partner, details of schedule, and a place of the schedule.
